(19) United States
(12) Patent Application Publication
(10) Pub. No.: US 2006/0281427 A1
(43) Pub. Date: Dec. 14, 2006

(54) Frequency change arrangement and radio frequency tuner

(75) Inventors: Ali Isaac, Bristol (GB); Nicholas Paul Cowley, Wiltshire (GB)

Correspondence Address: ARENT FOX PLLC, 1050 CONNECTICUT AVENUE, N.W., SUITE 400, WASHINGTON, DC, 20036, US

(73) Assignee: INTEL CORPORATION

(21) Appl. No.: 11/439,539

(22) Filed: May 24, 2006

(30) Foreign Application Priority Data
Jun. 8, 2005 (GB) 0511585.2

(51) Int. Cl. H04B 1/16

(52) U.S. Cl. 455/209

(57) ABSTRACT

A frequency changer arrangement is provided for a radio frequency tuner. The arrangement comprises a first quadrature frequency changer for converting a desired input channel to zero or near-zero intermediate frequency in-phase and quadrature signals. These signals are filtered by low pass filters, whose turnover frequencies may be varied so as to vary the intermediate frequency bandwidth. A second quadrature frequency changer upconverts the filtered signals and supplies these to a summer. The resulting output intermediate frequency is determined by the frequency of commutation signals in the second frequency changer so that the output intermediate frequency may be continuously varied to allow any desired frequency to be selected.

### TECHNICAL FIELD

The present invention relates to a frequency changer arrangement and to a radio frequency (RF) tuner. Such a tuner may be used, for example, for reception of television (TV) signals, digital audio broadcast (DAB) signals or data signals, for example from terrestrial or satellite antenna systems or cable distribution systems.

### BACKGROUND

A known type of tuner for receiving, for example, terrestrial or cable broadcast signals is of the single conversion type, in which a selected desired channel is converted to a required output intermediate frequency (IF) by a single frequency changer having a single mixing stage. The frequency changer is tunable so as to select the desired channel, for example in an input frequency range from 50 to 860 MHz. A typical example of an output intermediate frequency is 36 MHz.

In such a tuner, the frequency changer typically performs high side mixing such that the frequency of a commutating signal generator in the frequency changer is greater than the desired channel frequency by the intermediate frequency. Such a frequency changer converts the desired channel to the intermediate frequency but also converts an image channel, whose frequency is greater than the frequency of the desired channel by twice the intermediate frequency, to the intermediate frequency. It is therefore necessary to provide image channel cancellation or attenuation and this is typically achieved by providing a tracking filter arrangement ahead of the mixer stage of the frequency changer. The filter arrangement is generally divided between three stages to achieve the required tuning range and is in the form of a bandpass arrangement, whose centre frequency is arranged to track the frequency of the commutating signal generator output signal with a frequency offset equal to the intermediate frequency.

Another known type of tuner for such an application is of the double conversion type, in which the desired channel is converted to the required output intermediate frequency by two frequency changers, each having a mixing stage. The first frequency changer is an upconverter, which converts the frequency of the desired channel to a relatively high intermediate frequency greater than the maximum frequency of the input frequency range. The second frequency changer converts the desired channel at the high intermediate frequency to the required output intermediate frequency. Image cancellation or attenuation is provided by an intermediate frequency filter, typically of surface acoustic wave (SAW) type of fixed bandwidth, between the first and second frequency changers.

In both types of tuners, the desired channel at the output intermediate frequency is supplied to an intermediate frequency stage, which typically comprises a fixed frequency channel filter of SAW type and a variable gain IF amplifier. The output of the tuner is generally connected to a demodulator.

Different tuner applications require different intermediate frequencies and/or different bandwidths. For example, tuners intended for use in Europe are generally required to provide an output intermediate frequency of 36 MHz whereas tuners intended for use in USA are generally required to provide an output intermediate frequency of 44 MHz. Also, depending on the required frequency band of operation, the output intermediate frequency bandwidth may vary between 6 and 8 MHz.

As described hereinbefore, because of the use of fixed IF filtering in both known types of tuners, each tuner has to be designed and manufactured specifically for each application requiring different IF characteristics. The use of SAW filters prevents adjustment of the IF characteristics so that different tuners have to be manufactured for different applications and it is not possible to provide a single tuner which is capable of use in a range of applications sufficient to cover all present requirements.

In addition to the problems associated with the IF filtering, such known tuners also require further modifications, for example in hardware and/or in firmware, in order to allow the output intermediate frequency to be varied or adjusted to suit different applications. In the case of the single conversion tuner, the tracking filters track the commutating signal frequency with an offset equal to the output intermediate frequency. If the output intermediate frequency is varied, then the alignment of the tracking filters would have to be adjusted.

In the case of double conversion tuners, the two local oscillators associated with the two frequency changers interact with each other, resulting in in-band spurious signals, for example caused by mixing of local oscillator harmonics. As is known, compensation for this may be achieved by adjusting the high intermediate frequency. However, the local oscillator frequency depends on the intermediate frequency so that any adjustments cause a change in the “beat pattern”. Thus, firmware modifications would also be required to provide a variable intermediate frequency.

U.S. Pat. No. 4,653,117, GB 2236225, U.S. Pat. No. 5,584,066, EP 0782249 and U.S. Pat. No. 6,233,431 disclose image reject frequency changing arrangements comprising first and second quadrature frequency changers. The first frequency changer converts the incoming signal to zero intermediate frequency in-phase and quadrature signals, which pass through low pass filters to the second frequency changer. The second frequency changer converts the filtered signals to finite intermediate frequency signals, which are summed so as to reject the image signal.

EP 1182775 discloses a double conversion tuner comprising an upconverter followed by a zero intermediate frequency downconveter. The zero intermediate frequency in-phase and quadrature signals are filtered by low pass filters of variable cut-off frequency. The commutating signal frequency of the second frequency changer may be variable to permit tuning or adjustment.

### SUMMARY

According to a first aspect of the invention, there is provided a frequency changer arrangement for a radio frequency tuner, comprising a first quadrature frequency changer for converting an input signal to zero or near-zero intermediate in-phase and quadrature signals, first and second filters for filtering the in-phase and quadrature signals, respectively, a second quadrature frequency changer for converting the filtered in-phase and quadrature signals to finite intermediate frequency in-phase and quadrature signals, and a combiner for forming a linear combination of the finite intermediate frequency in-phase and quadrature signals, the second frequency changer being adjustable for selecting the finite intermediate frequency.

The term “finite intermediate frequency” as used herein means a frequency which is greater than half the bandwidth of the signal or channel being received.

The term “linear combination” as used herein refers to a combination of the form aI+bQ, where I and Q are the finite intermediate frequency in-phase and quadrature signals, respectively, and a and b are positive or negative non-zero parameters.

The first frequency changer may comprise first and second mixers and a first quadrature commutating signal generator.

The second frequency changer may comprise third and fourth mixers and a second quadrature commutating signal generator.

The first and second filters may have adjustable turnover frequencies for selecting an intermediate frequency passband.

The first and second filters may have the same turnover frequencies.

The first and second filters may be of substantially identical construction.

The first and second filters may be low pass filters.

The combiner may comprise a summer.

The arrangement may comprise an anti-alias filter after the combiner.

The arrangement may comprise a variable gain amplifier after the combiner.

The arrangement may comprise phase and/or amplitude adjustment means for maximising image cancelling.

According to a second aspect of the invention, there is provided a radio frequency tuner comprising an arrangement according to the first aspect of the invention.

The tuner may be of the single conversion type and the first frequency changer may be tuneable for selecting a channel for reception. The tuner may comprise at least one tracking filter ahead of the first frequency changer.

The tuner may be of the double conversion type and may comprise a third frequency changer ahead of the first frequency changer. The third frequency changer may be an upconverter. At least one of the first and third frequency changers may be tuneable for selecting a channel for reception. The tuner may comprise an intermediate frequency filter between the first and third frequency changers.

The tuner may comprise an automatic gain control arrangement ahead of the first frequency changer.

According to a third aspect of the invention, there is provided a radio frequency tuner comprising: a quadrature near-zero intermediate frequency frequency changer comprising a mixer arrangement for supplying in-phase and quadrature near-zero intermediate frequency signals and a local oscillator arrangement for supplying commutating signals to the mixer arrangement; a phase shifting arrangement for shifting the phase of at least one of the in-phase and quadrature near-zero intermediate frequency signals to form in-phase and quadrature intermediate frequency signals I and Q; a combiner for forming a linear combination aI+bQ, where a and b are parameters; a tuning arrangement for tuning a desired channel to be on the high or low frequency side of the commutating signals; and a controller for selecting on which frequency side of the commutating signals the desired channel is disposed and whether the parameters a and b have the same or opposite signs in accordance with the level of at least one adjacent undesired channel.

The parameters a and b may have the same signs when the desired channel is on the high frequency side of the commutating signals and may have opposite signs when the desired channel is on the low frequency side of the commutating signals.

The tuning arrangement may include the local oscillator arrangement.

The parameters a and b may be substantially equal to one.

The parameters a and b may be adjustable for maximising image cancelling.

The mixer arrangement may comprise first and second mixers and the local oscillator arrangement may comprise a first quadrature commutating signal generator.

The tuner may comprise first and second filters between the mixer arrangement and the combiner. The first and second filters may have adjustable turnover frequencies for selecting an intermediate frequency passband. The first and second filters may have the same turnover frequencies. The first and second filters may be low pass filters.

The phase-shifting arrangement may comprise at least one of the first and second filters.

The phase-shifting arrangement may comprise a quadrature upconverter for forming the signals I and Q as finite intermediate frequency signals. The upconverter may comprise third and fourth mixers and a second quadrature commutating signal generator. The upconverter may be adjustable for selecting the finite intermediate frequency.

The controller may be arranged to perform the selection so as to minimise interference.

The controller may be arranged to determine the level of the at least one adjacent channel from a map obtained by causing the tuner to scan all channels at switch-on and by measuring and storing as the map the channel levels.

The controller may be arranged to determine the level of the at least one adjacent channel in response to a channel selection request by causing the tuner to tune to the at least one adjacent channel and measuring the channel level before tuning to the desired channel.

The at least one adjacent channel may comprise the immediately adjacent upper and lower channels.

It is thus possible to provide a frequency changer arrangement and tuner which may be used to provide any desired output intermediate frequency and intermediate frequency bandwidth. For example, by forming the zero or near-zero intermediate frequency channel filters as integrated active filters, such filters may readily be controlled or adjusted to provide any desired bandwidth for any application or to provide variable bandwidth to allow the bandwidth to be selected according to requirements during use of a tuner. Similarly, a local oscillator in the second frequency changer may be of adjustable or variable frequency to allow any desired output intermediate frequency to be provided for different applications or to allow the output intermediate frequency to be varied during use of the tuner according to the requirements of the received signals. It is possible and may be desirable to provide some form of calibration in order to improve or optimise the balance of quadrature generators within the arrangement. If such calibration is provided, it is sufficient, in order to compensate for quadrature imbalances introduced by any stage, that one of the quadrature converters be adjusted.

Such an arrangement may be in the form of a single monolithic integrated circuit incorporating most or all of the components of a complete tuner. A single tuner “architecture” may be provided which is suitable for a very wide range of applications and which requires minimal adjustment or adaptation, during manufacture or during use, in order to adapt such an architecture to any specific requirement. By providing “infinite variability” in output intermediate frequency and bandwidth, such a tuner architecture may be used for future, as yet undefined, applications in addition to a wide range of existing applications.

It is also possible to provide a tuner based on near-zero intermediate frequency techniques allowing interference from an adjacent channel to be reduced. Tuner performance may therefore be improved.

### BRIEF DESCRIPTION OF THE DRAWINGS

FIG. 1 is a block circuit diagram of a frequency changer arrangement and tuner comprising an embodiment of the invention;

FIG. 2 is a block circuit diagram of a first type of pre-IF stage of the tuner of FIG. 1;

FIG. 3 is a block circuit diagram of a second type of pre-IF stage of the tuner of FIG. 1;

FIG. 4 illustrates the frequency spectra of signals at various points of the tuner of FIG. 1;

FIG. 5 is a block circuit diagram of a tuner constituting another embodiment of the invention; and

FIGS. 6 and 7 illustrate frequency spectra during operation of the tuner of FIG. 5.

Like reference numerals refer to like parts throughout the drawings.

### DETAILED DESCRIPTION

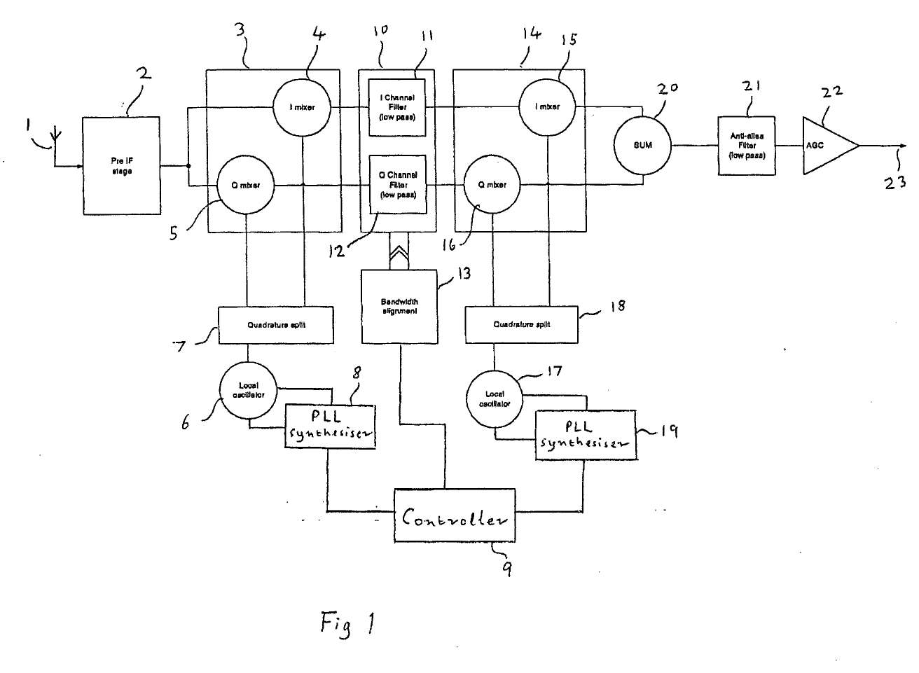

The radio frequency tuner shown in FIG. 1 has an input 1 for receiving TV, DAB or digital data signals from a broadcast or distribution arrangement such as a terrestrial aerial, a satellite aerial arrangement or a cable distribution network. The input 1 is connected to the input of a pre-IF stage 2, whose structure depends on the specific tuner type. Examples of the stage 2 will be described hereinafter.

The output of the stage 2 is connected to a mixer stage 3, comprising I and Q mixers 4 and 5. The mixers 4 and 5 have signal inputs connected to the output of the stage 2 and commutating signal inputs. The commutating signals are generated by a local oscillator 6 and a quadrature signal generator 7, whose outputs supply signals in phase-quadrature to the commutating signal inputs of the mixers 4 and 5. The local oscillator 6 is controlled by a phase locked loop (PLL) synthesiser 8, which in turn is controlled by a controller 9. The stages 3 to 8 form a first quadrature frequency changer, which converts an input signal to zero or near-zero intermediate frequency in-phase and quadrature signals I and Q.

The outputs of the mixers 4 and 5 are supplied to a quadrature filter stage 10 comprising I and Q channel low pass filters 11 and 12. The turnover frequencies of the filters 11 and 12 are controlled by a bandwidth alignment stage 13, which is controlled by the controller 9.

The filtered output signals from the stage 10 are supplied to a second mixer stage 14 comprising I and Q mixers 15 and 16. Commutating signals for the mixers 15 and 16 are generated by a local oscillator 17 and supplied by a quadrature signal generator 18. The local oscillator 17 is controlled by the PLL synthesiser 19, which is controlled by the controller 9. The stages 15 to 19 form a second quadrature frequency changer, which supplies I and Q output signals of finite output intermediate frequency.

The output signals of the second frequency changer are supplied to a summer 20, which forms the linear combination I+Q as the sum of the second frequency changer output signals. The output of the summer 20 is supplied to an anti-alias low pass filter 21, whose output is supplied to an automatic gain control (AGC) stage 22 including a variable gain amplifier. The output of the stage 22 is supplied to the output 23 of the tuner, which may be connected to one or more demodulators for extracting the desired signal from a desired channel.

In the case where the first frequency changer converts the desired channel to zero intermediate frequency, it is not essential for the conversion to be wholly accurate. In particular, if there is a small offset from zero frequency, whether positive or negative, this can be corrected in the vector mathematics embodied by the first and second frequency converters.

For zero intermediate frequency, the low pass filters 11 and 12 are controlled or arranged to have a turnover frequency which is at or just above half the bandwidth of the selected desired channel. Although the actual turnover frequency depends mainly on the desired channel bandwidth, it may also be dependent on other factors, such as the ratio of the maximum adjacent channel power to that of the desired channel and the size of any downstream analogue/digital converter (ADC), for example in an associated demodulator. The filtering performed by the filters 11 and 12 effectively provides channel filtering for passing the desired channel while substantially rejecting or greatly attenuating at least the adjacent channels. These filters also provide attenuation to the image channel associated with the second frequency converter 14-19.

Depending on the specific type of the tuner, the controller 9 may control the synthesiser 8 such that the first frequency changer 3-8 performs some or all of the tuning to select the desired channel for reception. The controller 9 provides the appropriate control signals to the synthesiser 8, for example based on selection by a user of a channel for reception.

The controller 9 is shown as controlling the synthesiser 19, which sets or adjusts the frequency of the local oscillator 17 and hence of the commutation signals supplied to the mixer stage 14. In the case where the first frequency changer 3-8 converts the desired channel to zero intermediate frequency, the frequency of the commutating signals in the second frequency changer 14-19 is equal to the output intermediate frequency, which may therefore be set merely by setting the local oscillator 17 to the appropriate frequency (which may be a multiple of the output intermediate frequency if the stage 18 performs frequency division as part of the process for generating the quadrature commutation signals). The output intermediate frequency may therefore be selected or changed by the controller 9. The operation of the frequency changer arrangement 3-8, 10-19 relies on the accuracy of the quadrature mixing in the first and second frequency changers so that the performance of the arrangement may be improved by providing a facility for measuring any quadrature imbalance introduced through the dual conversion frequency changer arrangement and adjusting at least one of the quadrature signal generators 7 and 18 in order to correct this. Similarly, the summer 20 may be adjusted to form the linear combination aI+bQ, where a and b are adjustable parameters or “constants” which differ from 1 so as to reduce any imbalance.

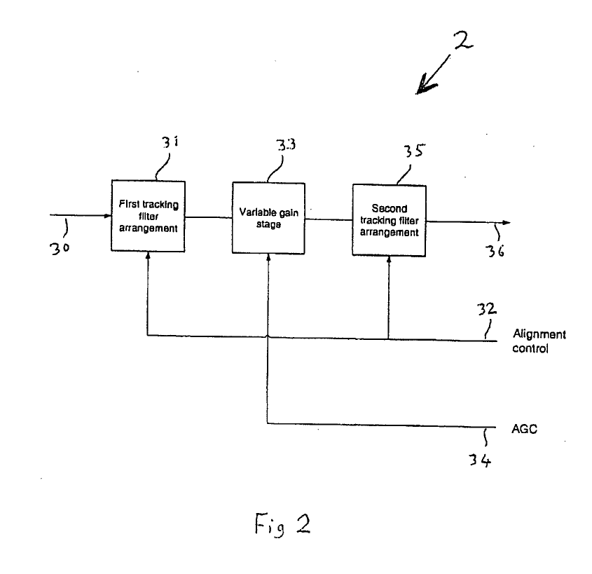

FIG. 2 illustrates an example of the stage 2 in the case where the tuner of FIG. 1 is of the single conversion type. The stage 2 has an input 30 connected to a first tracking filter arrangement 31. For example, the filter arrangement 31 may comprise a bandpass filter whose centre frequency is controlled via the control input 32 so as to track or follow the frequency of the commutation signals of the first frequency changer 3-8. Because the first frequency changer 3-8 is, in the embodiment described hereinbefore, of the zero intermediate frequency type, the filter centre frequency is arranged to be as close as reasonably possible to the frequency of the commutating signals. The input 32 may, for example, be connected to the control voltage output of the synthesizer 8 connected to a voltage-controlled resonantor “tank” circuit of the local oscillator 6.

The output of the filter arrangement 31 is connected to the input of a variable gain amplifier 33, whose gain is controlled by an automatic gain control (AGC) signal at an input 34. The stage 33 is generally required to have a wide dynamic range and its gain may be controlled in accordance with the signal strength in part of the received frequency spectrum including the desired channel so as to provide a desired signal level at the output 36 of the stage 2. The output of the stage 33 is connected to a second tracking filter arrangement 35, which may have a similar characteristic to that of the first filter arrangement 34. The combination of the tracking filter arrangements 31 and 35 is arranged to provide a desired level of attenuation to potentially interfering signals.

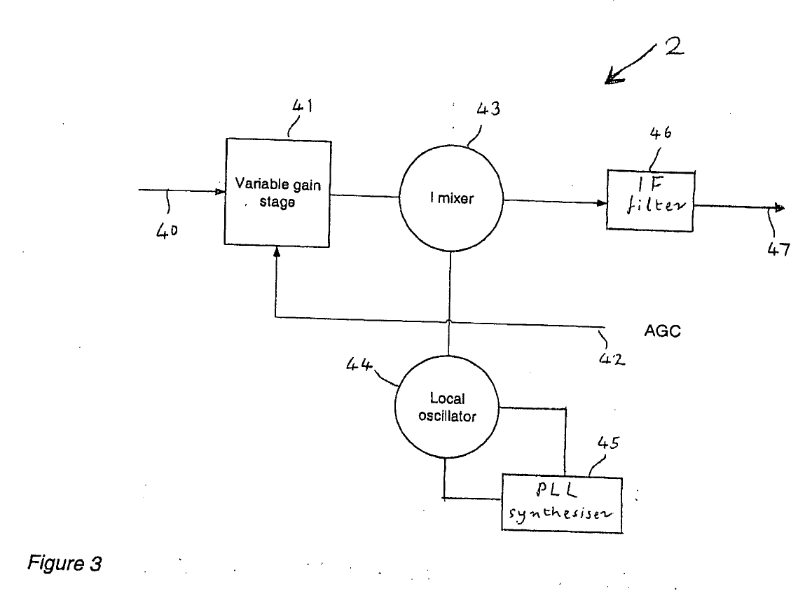

The stage 2 shown in FIG. 3 is suitable for a tuner of the double conversion type. The stage comprises an input connected to a variable gain stage 41 having an AGC control signal input 42 of the same type as described with reference to FIG. 2. The output of the stage 41 is supplied to a mixer 43 provided with a local oscillator 44 and a PLL synthesiser 45 to form a frequency changer of the upconverter type. The output of the mixer 43 supplies a signal at a first relatively high intermediate frequency, in particular above the highest frequency of the input band. The IF signal is filtered by a bandpass filter 46 and supplied to the output 47 of the stage 2.

Either or both of the frequency changers 3-8 and 43-45 may be controlled so as to select the desired channel for reception. For example, tuning may be at least mainly performed in the frequency changer 43-45, for example by supplying the appropriate control signals to the synthesiser 45 from the controller 9. In this case, the desired channel is converted to the high intermediate frequency and the synthesiser 8 is controlled to provide fixed downconversion or to permit some variation for fine tuning or for avoiding interference products. In this case, the bandpass filter 46 has a relatively narrow passband centred on the high intermediate frequency so as to pass the desired channel and one or more channels on either side thereof while attenuating all other channels at the output of the mixer 43.

In another embodiment, the frequency changer 43-45 may be arranged to perform substantially fixed upconversion so that the input signal band is converted to a higher frequency band. The synthesiser 8 is then controlled by the controller 9 so as to select the desired channel and convert it to zero (or near-zero) intermediate frequency. Again, the substantially fixed up conversion performed by the frequency changer 43-45 may permit some variation for fine tuning or interference reduction. In this case, the filter 46 may be omitted or may be of very broad passband.

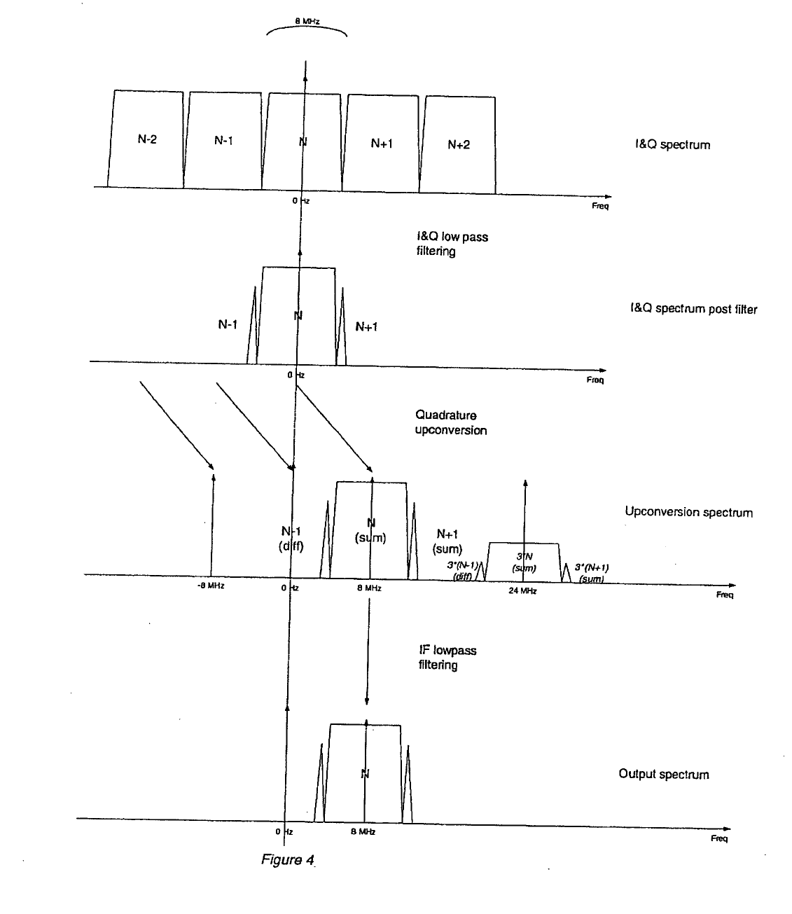

FIG. 4 illustrates the frequency conversion plan of the tuner shown in FIG. 1. It is assumed that the input broadband signal at the input 1 of the tuner comprises a plurality of evenly spaced substantially contiguous channels with the desired channel being labelled “N” and the other channels being numbered relative to this.

The signal supplied to the input of the first frequency changer 3-8 is converted to substantially zero intermediate frequency such that the desired channel N is centred just above zero Hz. The resulting spectrum is illustrated as the “I & Q spectrum” in the top graph of FIG. 4 with at least some of the adjacent channels N±1, N±2 being present in the converted signal. The I and Q signals from the mixers 4 and 5 are filtered by the low pass filters 11 and 12, respectively, to give the “I & Q spectrum post filter” illustrated in the second graph in FIG. 4. The filtering is such that the desired channel N is passed with little or no attenuation whereas all other adjacent channels are substantially attenuated or eliminated. FIG. 4 illustrates the case where the filters 11 and 12 remove most of the adjacent channels N±1 and remove all of the other undesired channels.

The filtered signals are then upconverted in the frequency changer 14-19 and summed in the summer 20 to give the “upconversion spectrum” illustrated in the third graph of FIG. 4. The vector relationship between the I and Q channels is such that: (i) there is constructive addition of sum products for carriers which originate in the positive frequency plane and for difference products for carriers which originate in the negative frequency plane; and (ii) there is cancellation of difference products which originate in the positive frequency plane and of sum products which originate in the negative frequency plane. In this example, the output intermediate frequency is 8 MHz and the two frequency changing steps result in the desired channel N being centred on the 8 MHz intermediate frequency.

The upconversion performed by the frequency changer 14-19 may result in the generation of third harmonic products centred on 24 MHz. Such aliasing components are removed or greatly attenuated by the filter 21 so that the “output spectrum” at the output 23 of the tuner is as shown in the bottom graph of FIG. 4.

It is thus possible to provide a tuner which is capable of providing a continuously variable IF bandwidth and output intermediate frequency. Such a tuner may be embodied with a high degree of integration. For example, the whole or substantially the whole of such a tuner may be embodied by a single monolithic integrated circuit.

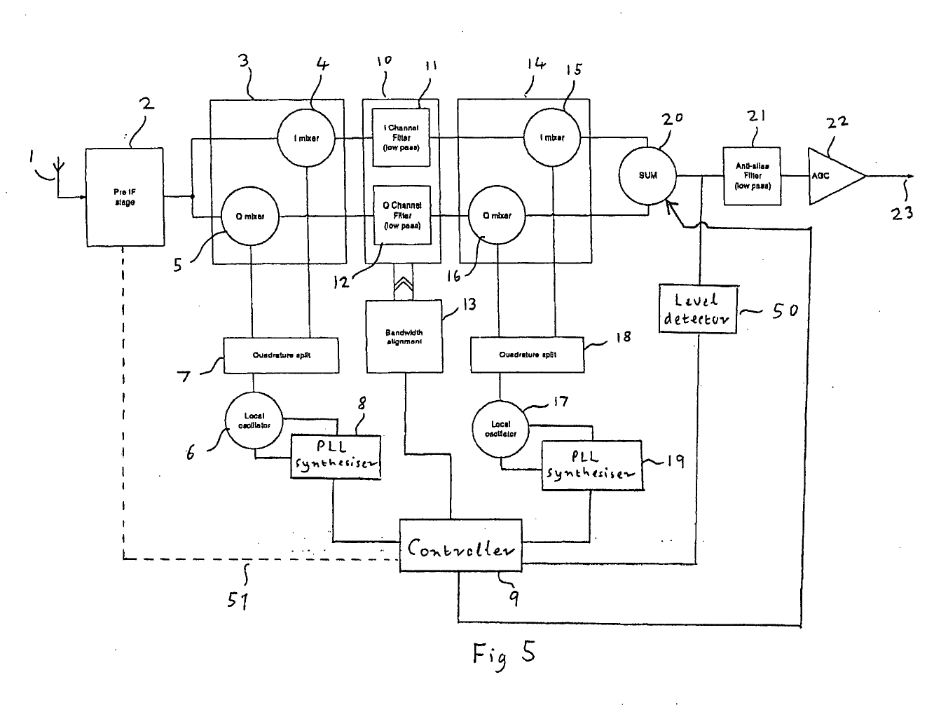

The tuner shown in FIG. 5 differs from that shown in FIG. 1 in that a level detector 50 is provided for measuring the signal level at the output of the combiner 20 and supplying this to the controller 9. Also, the controller 9 controls whether the combiner 20 forms the sum of or difference between the I and Q signals from the mixers 15 and 16, respectively. Further, in some embodiments, the controller may supply control signals on a line 51 to a frequency converter in the stage 2.

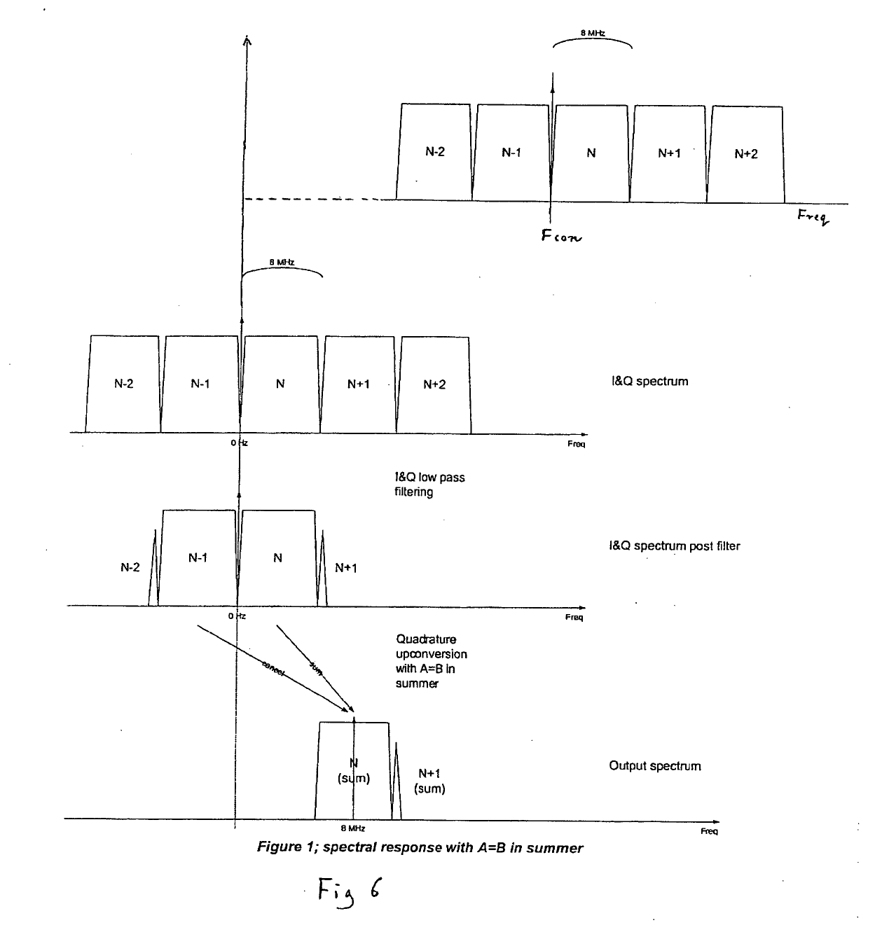

In this embodiment, the frequency changer 3-8 is of the near-zero intermediate frequency type. In particular, the frequency of the commutating signals supplied to the mixers 4 and 5 can be selected to be at the upper or lower end of the desired channel. FIG. 6 illustrates the frequency spectra for the case where the frequency Fcon which is effectively converting the desired channel N to near-zero intermediate frequency is at the lower end of the frequency range of the desired channel. This is illustrated in the upper graph of FIG. 6.

Following conversion in the first frequency changer 3-8, the resulting “I+Q spectrum” is as shown in the second graph in FIG. 6. The desired channel of 8 MHz bandwidth is centred on 4 MHz in the positive frequency plane and extends from zero to 8 MHz. The adjacent channels retain their same positions in the frequency domain relative to the desired channel.

Following filtering by the filters 11 and 12, the resulting “I+Q spectrum post filter” is shown in the third graph in FIG. 6. The filtering substantially removes the undesired adjacent channel above the channel N+1 and below N−2 and greatly attenuates the channels N+1 and N−2.

The bottom graph in FIG. 6 illustrates the “output spectrum” following upconversion by the frequency changer 14-19 and summing of the upconvereted signals by the summer 20 (or after filtering by the filter 21). As in the spectra illustrated in FIG. 4, the output intermediate frequency is, in this example, 8 MHz. With the summer 20 forming the sum of the I and Q signals from the mixers 15 and 16, carriers in the positive frequency plane are summed whereas carriers in the negative frequency plane are substantially cancelled. Thus, the adjacent channel N−1 and the residue of the next-adjacent channel N−2 are cancelled or greatly attenuated by the vector addition of the I and Q signals from the mixers 15 and 16 in the summer 20.

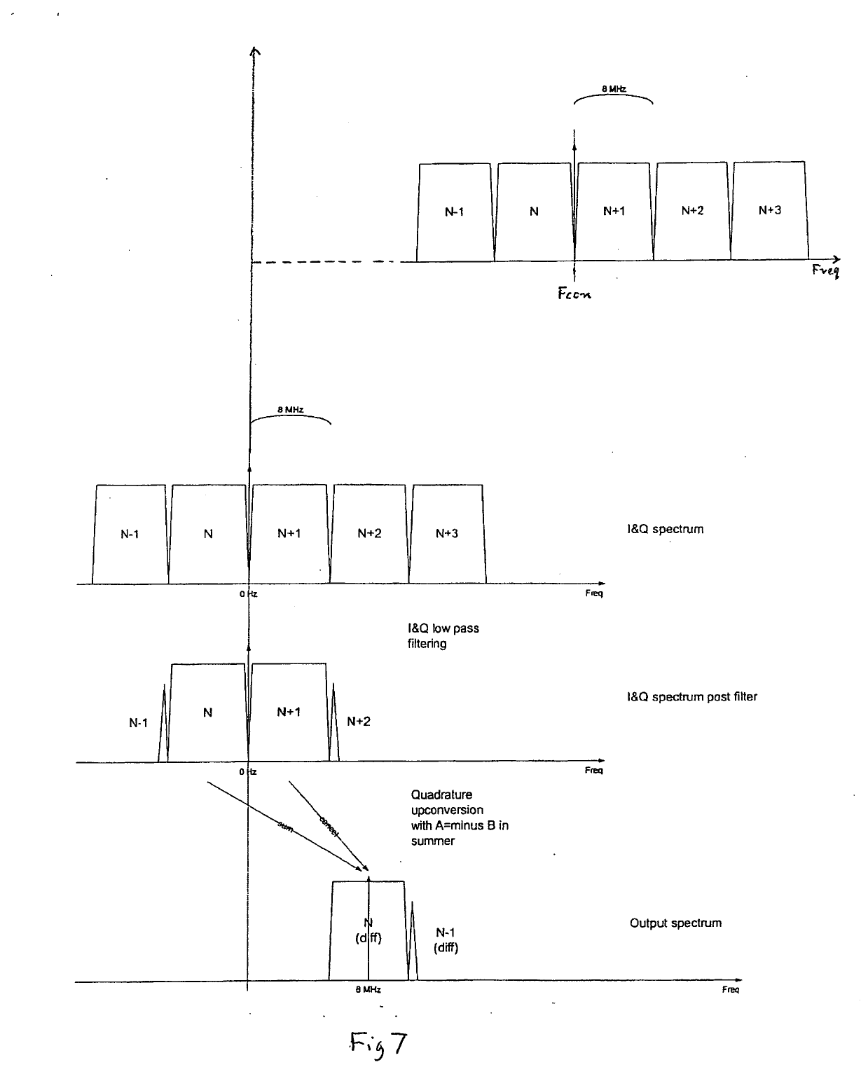

FIG. 7 illustrates the spectra which occur when the effective conversion frequency Fcon is at the upper end of the desired channel N and the summer 20 forms the difference I-Q (or Q-I). In this case, the controller 9 controls the synthesiser 8, and possibly a synthesiser in the stage 2, to select local oscillator frequencies for the downconversion to near-zero intermediate frequency such that the desired channel N is centred on 4 MHz in the negative frequency plane as illustrated by the second graph in FIG. 7. The third graph illustrates the effect of filtering by the filters 11 and 12 and the bottom graph illustrates the result of vector “addition” in the summer 20 to form the difference between the filtered I and Q signals.

In this case, the vector addition results in summation of carriers in the negative frequency plane and substantial cancellation of carriers in the positive frequency plane. Thus, the adjacent channel N+1 and the residue of the next-adjacent channel N+2 are substantially cancelled or greatly attenuated.

The tuner may be operated in either of the modes illustrated in FIGS. 6 and 7 in order to receive the desired channel N. However, the difference between these modes is that, when the mode illustrated in FIG. 6 is used, the undesired energy which is passed to the tuner output mainly corresponds to the undesired channel N+1 whereas, in the mode illustrated in FIG. 7, the undesired energy mainly corresponds to the undesired channel N−1. In the mode illustrated in FIG. 6, suppression to reduce the undesired energy in the channel N+1 is provided by the filters 15 and 16. Conversely, in the mode illustrated in FIG. 7, the undesired energy from the channel N−1 is mainly suppressed by the filtering provided by the filters 15 and 16.

It is thus possible to choose between the modes illustrated in FIG. 6 and FIG. 7 in order to minimise interference by selecting which adjacent channels are attenuated by filtering and which are attenuated by phase cancellation. For example, in reception conditions where the undesired immediately-adjacent channels N+1 and N−1 are of different amplitudes, the better of the conversion modes illustrated in FIGS. 6 and 7 may be selected, for example so that the adjacent channel which has the lower energy lies in the same frequency plane as the desired channel and the other immediately-adjacent channel of higher amplitude is attenuated by the filtering. This reduces the required cancellation accuracy and also reduces the signal handling requirements for the higher amplitude adjacent channel.

Any suitable technique for establishing which of the two conversion modes illustrated in FIGS. 6 and 7 should be selected may be used. For example, each time the tuner is switched on, the controller 9 may be arranged to cause the tuner to scan through the input signal spectrum so as to tune to each available channel in turn while monitoring the channel level detected by the detector 50. A “map” of the levels in the channels may thus be formed and the controller 9 refers to this map when receiving a request for reception of a desired channel so as to establish whether the mode shown in FIG. 6 or the mode shown in FIG. 7 should be adopted for reception of that channel. It is preferable for the map to be constructed when the tuner is switched on, rather than relying on a previously constructed map, so as to assess the prevailing reception conditions and hence allow interference to be minimised. If appropriate and subject to any undesirable artefacts caused by scanning being at a level which is acceptable to a user, the scanning and map construction may be performed more frequently during use of the tuner so as to allow the better mode of operation to be selected for each desired channel when prevailing reception conditions change.

Alternatively or additionally, the controller 9 may be arranged, in response to a channel selection request by a user, to tune to at least each of the immediately-adjacent undesired channels so as to measure their signal levels before tuning to the desired channel. As a result of this, the controller 9 determines which of the modes shown in FIGS. 6 and 7 is better for the prevailing conditions and adopts the better mode for reception of the desired channel.

In order for this cancellation technique to be effective, the first frequency changer 3-8 is required to be of the near-zero intermediate frequency type and of quadrature type. The second frequency changer 14-19 performs two main functions, namely converting the signal to a desired finite output intermediate frequency and changing the relative phases of the I and Q signals so that the linear combination formed in the summer 20 provides the desired image cancellation. However, the frequency changer 14-19 may be replaced by any other suitable means for providing the required phase difference between the signals supplied to the summer 20. For example, where the output signal is required to be at near-zero intermediate frequency, it is unnecessary to provide any frequency changing of the signals supplied to the summer 20. Thus, the frequency changer 14-19 may be replaced by a phase-changing network in either or both of the signal paths. Such a phase-changing function may, for example, be performed within either or both of the filters 11 and 12.

What is claimed is:

1. A frequency changer arrangement for a radio frequency tuner, said frequency changer arrangement comprising: a first quadrature frequency changer for converting an input signal to intermediate frequency in-phase and quadrature signals of one of zero intermediate frequency and near-zero intermediate frequency; first and second filters for filtering said in-phase and quadrature signals, respectively, to form filtered in-phase and quadrature signals; a second quadrature frequency changer for converting said filtered in-phase and quadrature signals to finite intermediate frequency in-phase and quadrature signals of a finite intermediate frequency, said second frequency changer being adjustable for selecting said finite intermediate frequency; and a combiner for forming a linear combination of said finite intermediate frequency in-phase and quadrature signals.

2. An arrangement as claimed in claim 1, in which said first frequency changer comprises first and second mixers and a first quadrature commutating signal generator.

3. An arrangement as claimed in claim 1 or 2, in which said second frequency changer comprises third and fourth mixers and a second quadrature commutating signal generator.

4. An arrangement as claimed in claim 1, in which said first and second filters have adjustable turnover frequencies for selecting an intermediate frequency passband.

5. An arrangement as claimed in claim 1, in which said first and second filters have a same turnover frequency.

6. An arrangement as claimed in claim 1, in which said first and second filters are of substantially identical construction.

7. An arrangement as claimed in claim 1, in which said first and second filters are low pass filters.

8. An arrangement as claimed in claim 1, in which said combiner comprises a summer.

9. An arrangement as claimed in claim 1, comprising an anti-alias filter after said combiner.

10. An arrangement as claimed in claim 1, comprising a variable gain amplifier after said combiner.

11. An arrangement as claimed in claim 1, comprising at least one of phase and amplitude adjustment means for maximising image cancelling.

12. A radio frequency tuner including a frequency changer arrangement comprising: a first quadrature frequency changer for converting an input signal to intermediate frequency in-phase and quadrature signals of one of zero intermediate frequency and near-zero intermediate frequency; first and second filters for filtering said in-phase and quadrature signals, respectively, to form filtered in-phase and quadrature signals; a second quadrature frequency changer for converting said filtered in-phase and quadrature signals to finite intermediate frequency in-phase and quadrature signals of a finite intermediate frequency, said second frequency changer being adjustable for selecting said finite intermediate frequency; and a combiner for forming a linear combination of said finite intermediate frequency in-phase and quadrature signals.

13. A tuner as claimed in claim 12 of single conversion type, in which said first frequency changer is tunable for selecting a channel for reception.

14. A tuner as claimed in claim 13, comprising at least one tracking filter ahead of said first frequency changer.

15. A tuner as claimed in claim 12 of double conversion type, comprising a third frequency changer ahead of said first frequency changer.

16. A tuner as claimed in claim 15, in which said third frequency changer is an upconverter.

17. A tuner as claimed in claim 15, in which at least one of said first and third frequency changers is tunable for selecting a channel for reception.

18. A tuner as claimed in claim 15, comprising an intermediate frequency filter between said first and third frequency changers.

19. A tuner as claimed in claim 12, comprising an automatic gain control arrangement ahead of said first frequency changer.

20. A radio frequency tuner comprising: a quadrature near-zero intermediate frequency frequency changer comprising a mixer arrangement for supplying in-phase and quadrature near-zero intermediate frequency signals and a local oscillator arrangement for supplying commutating signals to said mixer arrangement; a phase-shifting arrangement for shifting a phase of at least one of said in-phase and quadrature near-zero intermediate frequency signals to form in-phase and quadrature intermediate frequency signals I and Q; a combiner for forming a linear combination aI+bQ, where a and b are parameters; a tuning arrangement for tuning a desired channel to be on one of a high frequency side and a low frequency side of said commutating signals; and a controller for selecting on which frequency side of said commutating signals said desired channel is disposed and whether said parameters a and b have a same sign or opposite signs in accordance with a level of at least one adjacent undesired channel.

21. A tuner as claimed in claim 20, in which said parameters a and b have said same signs when said desired channel is on said high frequency side of said commutating signals and have said opposite signs when said desired channel is on said low frequency side of said commutating signals.

22. A tuner as claimed in claim 20, in which said tuning arrangement includes said local oscillator arrangement.

23. A tuner as claimed in claims 20, in which said parameters a and b and substantially equal to one.

24. A tuner as claimed in claim 20, in which said parameters a and b are adjustable for maximising image cancelling.

25. A tuner as claimed in claim 20, in which said mixer arrangement comprises first and second mixers and said local oscillator arrangement comprises a quadrature commutating signal generator.

26. A tuner as claimed in claim 20, comprising first and second filters between said mixer arrangement and said combiner.

27. An arrangement as claimed in claim 26, in which said first and second filters have adjustable turnover frequencies for selecting an intermediate frequency passband.

28. An arrangement as claimed in claim 26, in which said first and second filters have a same turnover frequency.

29. An arrangement as claimed in claim 26, in which said first and second filters are low pass filters.

30. An arrangement as claimed in claim 26, in which said phase-shifting arrangement comprises at least one of said first and second filters.

31. An arrangement as claimed in claim 20, in which said phase-shifting arrangement comprises a quadrature upconverter for converting said signals I and Q to signals of a finite intermediate frequency.

32. An arrangement as claimed in claim 31, in which said upconverter comprises first and second mixers and a quadrature commutating signal generator.

33. An arrangement as claimed in claim 31, in which said upconverter is adjustable for selecting said finite intermediate frequency.

34. A tuner as claimed in claim 20, in which said controller is arranged to perform said selection so as to minimise interference.

35. A tuner as claimed in claim 20, in which said controller is arranged to determine said level of said at least one adjacent channel from a map obtained by causing said tuner to scan all channels at switch-on and by measuring and storing as said map a level of each said channel.

36. A tuner as claimed in claim 20, in which said controller is arranged to determine said level of said at least one adjacent channel in response to a channel selection request by causing said tuner to tune to said at least one adjacent channel and measuring said channel level before tuning to said desired channel.

37. A tuner as claimed in claim 20, in which said at least one adjacent channel comprises immediately adjacent upper and lower channels.
